(19) United States
(12) Patent Application Publication
(10) Pub. No.: US 2007/0209396 A1
(43) Pub. Date: Sep. 13, 2007

(54) Process of fining glassmelts using helium bubbles

(76) Inventors: Hisashi Kobayashi, Putnam Valley, NY (US); Scot Eric Jaynes, Lockport, NY (US); Rudolf Gerardus Catherina Beerkens, Swalmen (NL)

Correspondence Address: PRAXAIR, INC.;LAW DEPARTMENT - M1 557, 39 OLD RIDGEBURY ROAD, DANBURY, CT, 06810-5113, US

(21) Appl. No.: 11/803,136

(22) Filed: May 11, 2007

Related U.S. Application Data
(63) Continuation of application No. 10/413,468, filed on Apr. 15, 2003.

(51) Int. Cl. C03B 32/00

(52) U.S. Cl. 65/134.9

(57) ABSTRACT

A process for removing blisters (large bubbles in a glassmelt) and seeds (small bubbles in a glassmelt) from a glassmelt by feeding helium bubbles having a diameter between about 0.5 cm and about 3 cm at a prescribed flow rate and location to effectively produce a substantially bubble-free article.

This application is a continuation of copending application Ser. No. 10/413,468, filed Apr. 15, 2003.

### FIELD OF THE INVENTION

This invention is generally related to a process for removing gas bubbles in glass production. More specifically, this invention is related to a process for removing glass bubbles containing selected gases from a glassmelt by feeding helium gas bubbles through the glassmelt at a prescribed flow rate and location to effectively produce a substantially bubble-free glass article.

### BACKGROUND OF THE INVENTION

Glass is made by placing raw materials into a glass furnace to be melted. In a typical container glass furnace, solid batch (raw glass forming material) is fed to the charge end of the “melter” section of the furnace and becomes liquid (glassmelt) as the batch moves towards the hot spot or spring zone of the furnace. The raw materials that make up a batch will vary in composition and physical properties depending on the type of glass being produced. Batch materials typically include sand, soda ash, limestone and other minerals containing glass forming and modifying oxides (e.g. silicon dioxide, boron trioxide, calcium oxide, magnesium oxide, sodium oxide, potassium oxide and lead oxide), cullet (i.e., recycled glass), oxidizers (nitrate and sulfate), and fining agents (e.g., sodium sulfate, carbon, arsenic pentoxide, antimony pentoxide). For high value glasses, the liquid glass must become essentially bubble-free and homogeneous as it moves through the hot spot to the discharge end of the furnace. The temperature of the hot spot is adjusted depending on the glass composition to ensure that the desired chemical reactions take place to generate fining gases (e.g., oxygen and sulfur dioxide) and to grow small gas bubbles and float them to the glass bath surface. Molten glass leaves the hot spot and travels toward the throat which is the reduced cross section of furnace separating the melting section from the refining section. In the refiner, the glass is slowly cooled and gases in residual small bubbles (e.g. 200 microns or less in diameter) are adsorbed into the melt during slow cooling.

Furnaces using oxy-fuel (air is replaced with oxygen for combustion of natural gas or fuel oil) instead of air with fuel combustion, will have less environmentally hazardous emissions but can have processing problems with increased water in the furnace atmosphere. The prior art discusses the advantages and disadvantages of oxy-fuel furnaces with increased concentrations of water in the furnace atmosphere. Increased water in the furnace atmosphere increases the concentration of water in the melt. Additional water can reduce the amount of sulfate required to fine the melt. However, higher concentrations of water can cause foaming, color changes and processing concerns downstream.

Sodium sulfate is commonly used as a fining agent for soda-lime-silicate glass. Sodium sulfate will decompose to sulfur dioxide, oxygen and sodium oxide. The rate of decomposition and the final equilibrium in the melt will depend on the glassmelt chemistry and temperature. Sulfur dioxide and oxygen are desired gases to diffuse throughout the melt and grow other gas bubbles in the process of fining the melt. At the same time other dissolved gases in glassmelt diffuse into the growing bubble because the concentrations of other gases in the bubble are diluted by the fining gases. This phenomenon is known as “stripping” of dissolved gases and plays an important role in the gas re-absorption potential of the melt, or “refining”, of small residual bubbles when the glassmelt cools down. Furthermore, the amount of sulfur dioxide and oxygen will impact the redox state (usually described as the ratio Fe²⁺/Fe³⁺ in the melt) of the glass. Changing the redox state can change the color of the glass product.

The decomposition of sodium sulfate or other fining gases can be facilitated by increasing the temperature. Float glass and TV glass furnaces accomplish this by having a “spring zone” (location in the melter that has the highest temperature) or “hot spot” in the furnace. The glassmelt temperature in the spring zone can generally reach 1450-1550° C. The increase in temperature will improve the effectiveness of fining the glass by reducing melt viscosity and increasing the amount of sulfur dioxide and oxygen. However, the increase in temperature requires an additional energy input into the furnace and accelerates the furnace refractory wear rate.

Other fining agents or fining additives such as carbon, arsenic oxides, antimony oxides are also used, depending on the type of glass, to control the redox (i.e. reduction/oxidation) state of the glass. These other type of gas bubbles can be located before, along with or after the helium bubbles. However, carbon can have a negative impact on the tableware glass appearance in terms of dulling the brightness and color of the glass and arsenic and antimony create an environmental emissions concern.

The amount of batch fining agents can also be reduced by increasing the melt residence time. Increasing the residence time allows bubbles to rise through the melt to the furnace atmosphere. Increasing the residence time will proportionally decrease the pull rate for a furnace. Fining agents are generally needed, but an excessive amount of fining agents can create other product quality concerns and/or have negative environmental impacts.

U.S. Pat. No. 3,622,296 discloses a method of fining glass melts by fusing a glass composition in an atmosphere in which helium is substantially absent. Gaseous helium is passed into the molten glass such that helium diffuses through the glass and into the seeds (small bubbles) whereby the seeds expand to rise through the molten glass and become eliminated at the surface.

U.S. Pat. No. 3,960,532 discloses a process whereby the production of alkali metal silicate glass is achieved by vigorous steam bubbling through the molten glass bed during the preparation of glass by fusion. Such practice results in higher production using less fuel and the product water glass is easier to dissolve and results in water glass solutions of greater clarity.

It is an objective of the present invention to provide a process to remove gas bubbles composed of various gases such as sulfur dioxide, oxygen, water, carbon dioxide and nitrogen from glass. Glass must be effectively free of bubbles for consumer products such as tableware, TV panels, flat screen LCD glass, high quality containers and window glasses. Helium bubbling benefits glass manufacturers by reducing the percent rejected glass from carbon dioxide and nitrogen bubbles, reducing furnace emissions through reductions in sulfate, antimony and arsenic fining agents, and increasing furnace output.

Another object of the present invention is to provide a process to remove gas bubbles from a glassmelt by injecting in the glass bath through an array of nozzles small helium bubbles between about 0.5 to about 4 cm in diameter spaced several cm apart. Helium gas diffuses from helium gas bubbles into the melt and then to other gas bubbles in the glassmelt and rapidly grows the size of these bubbles, which rapidly rise to the glassmelt surface. Along with helium diffusing out of the helium bubble, soluble melt gases diffuse into the helium bubble and are stripped out of the glass. The stripping effect lowers the concentration of melt gases and reduces the probability of bubble formation during further process steps.

### SUMMARY OF THE INVENTION

The invention relates to a process for fining glassmelts comprising the steps:

(a) charging glass-based raw materials into a furnace and heating the raw materials sufficiently to form a glassmelt;

(b) feeding helium bubbles having a diameter of between about 0.5 cm and about 4 cm, preferably about 1 cm to 2 cm, into the glassmelt at an area in the furnace where the temperature of the glassmelt reaches about its highest level and preferably the helium bubbles being fed into the area before the temperature reaches its highest level;

(c) maintaining the helium bubbles in the glassmelt for a sufficient period of time to allow the helium gas from the helium bubbles to diffuse into the melt and to other gas bubbles in the glassmelt to produce larger bubbles having a diameter greater than about 0.1 cm, and causing the larger bubbles to rise to and then out from the glassmelt surface through buoyancy and simultaneously stripping other dissolved gases from the glassmelt so as to cause the smaller soluble gas bubbles (e.g. less than about 300 microns) to absorb in the glassmelt during cooling (a refining step); and

(d) cooling the glassmelt to produce a glass article preferably having less than about 5 seeds (small bubble in the glass) per cubic meter of glass.

Preferably, the rate of feeding the helium bubbles into the glassmelt should be between about 20 and about 250 bubbles per minute, more preferably between about 50 and about 150 per minute, and most preferably between about 60 and about 100 bubbles per minute per 1 mTPD (metric tons per day) of a glass pull rate. The glass pull rate for a glass furnace is defined as the amount of glass (usually in tons per day) that flows out the cold end of the furnace. Preferably, the helium can be fed into the furnace uniformly through two or more tubes spaced between about 1 cm and about 10 cm, and more preferably between about 3 cm and about 7 cm. Preferably, dissolved helium should be at between about 50% saturation and about 90% saturation just before or in the primary fining zone. The raw material (batch) can be heated between about 1000° C. and about 1650° C., and preferably between about 1300° C. and about 1550° C. to form the glassmelt. Preferably, there are less than 3 seeds per cubic meter of glass, and more preferably, 1 seed per cubic meter in the finished glass article.

### BRIEF DESCRIPTION OF THE DRAWINGS

The invention is hereinafter further described with reference to the accompanying drawings in which:

FIG. 1 shows a side schematic view of a glass furnace and a temperature profile of the furnace.

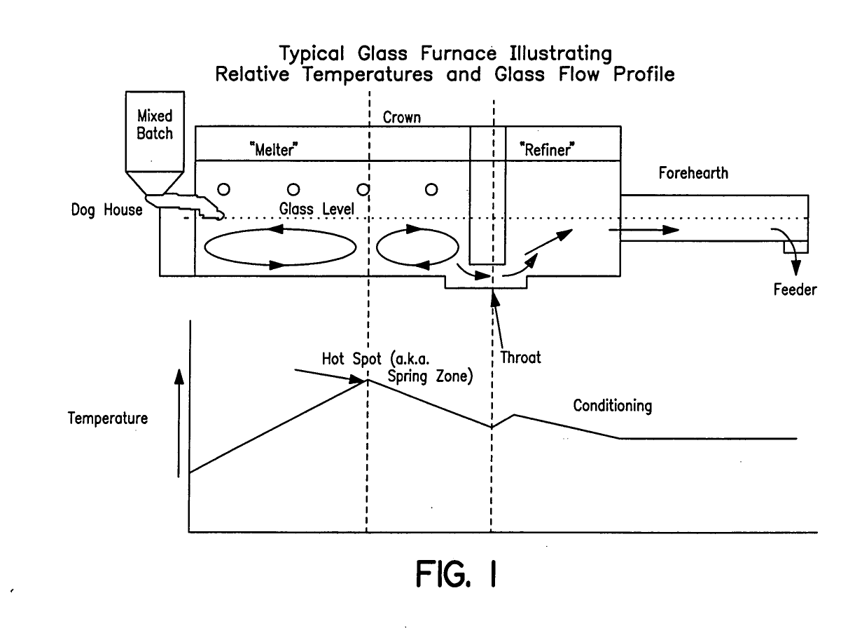

FIG. 2 is a side schematic view of a test laboratory crucible.

FIG. 3 shows a top schematic view of a glass furnace and a top schematic view of a partial section of a bubbler from the furnace.

FIG. 4 is a graph of bubble growth versus time during the fining in a sulfate containing soda-lime glassmelt based on a mathematical simulation of a single bubble with an initial diameter of 300 micron and initially containing 100% carbon dioxide.

FIG. 5 is a graph of the size of the resorption of small bubbles versus time, based on a mathematical simulation of a single bubble with an initial diameter of 300 micron.

### DETAILED DESCRIPTION OF THE INVENTION

According to the subject invention, selected helium bubble sizes and spacings are required, in addition to a proper helium gas flow rate, to effectively remove bubbles from the glassmelt. Based on numerical experiments using a mathematical model for single bubble behavior in a molten glass and laboratory experiments, it was found that beneficial effects of helium fining and economical application of helium can be achieved only within certain helium bubble sizes and that improper application of helium could cause defects of small helium bubbles or cause negative effects on re-absorption of seeds during cooling of glassmelt.

Glass manufacturers typically add one or more of several fining agents such as sulfates, sulfides, oxides of arsenic, antimony, or cerium, or sodium cloride to the batch. Except for sodium chloride, the above materials either decompose or react with oxygen to form gases with relatively low solubilities in the glass melt. The sodium chloride vaporizes into a vapor with low solubility. The newly formed gases increase the size of other bubbles as they diffuse through the glass melt into these bubbles. As bubbles grow in size they rise more rapidly to the melt surface through buoyancy and leave the glass melt into the furnace atmosphere. Of the above fining agents, float glass, tableware glass and container glass typically uses sodium sulfate.

The subject invention relates to a process for introducing helium bubbles at or before the spring zone of a furnace. The helium bubbles will allow helium to diffuse from the bubble into the melt and the concentration of the dissolved helium in glassmelt will increase. The dissolved helium will diffuse into other bubbles containing carbon dioxide, nitrogen, oxygen, water, sulfur dioxide and other gases and will accelerate the growth of these bubbles and at the same time dilute the concentrations of these gases in the bubble. At the same time, these soluble gases in the melt will diffuse into the rising helium bubble as well as into the helium diluted bubbles containing other gases and the concentrations of these gases will decrease, i.e., helium bubbles strip other dissolved gases in glassmelt. The bubbling action has an additional benefit of gently stirring and homogenizing the melt.

The helium bubbles of the subject invention are small and sized about 0.5 cm and no larger than about 4 cm in diameter and preferably no larger than 2 cm. Helium bubbles less than 0.5 cm could have too much helium diffuse out of the bubble, leaving a very small helium bubble in the melt. The small bubble would not have the necessary buoyancy to rise out of the melt within the normal residence time of a commercial glass melting tank. The small helium bubble would then develop its own glass defect. In comparison, a bubble 0.5 cm in diameter has an ascension time of 800 seconds. Bubbles larger than 4 cm will drastically increase the helium consumption without substantially increasing the amount of helium that diffused into the melt. For a 250 ton/day furnace, a 70 to 75% helium saturation in glassmelt will require approximately 40 Nm³ (normal m³) of helium per day with 2 cm bubbles, corresponding to only 0.0067 Nm³/Hr per 1 mTPD of glass pull. Large helium bubbles would have low residence times in the melt and not optimize diffusion of helium from the bubble to the melt and gases from the melt into the helium bubble. The predicted ascension time for a 2 cm in diameter bubble is about 37 seconds per meter at 1350 to 1400° C. A 4 cm bubble has a predicted ascension time of about 9 seconds per meter. In comparison to a 40 m³ of helium per day for a 2 cm bubble, a 4 cm bubble is expected to use 122 m³ of helium which corresponds to 0.020 Nm³/Hr per 1 mTPD of glass pull. The above ascension times, bubble sizes and diffusion rates were based on a melt at 1400° C. with a typical container or float glass composition.

In order for all the gas bubbles to float out of the glassmelt, it is important to distribute uniformly helium bubbler nozzles with a certain spacing between nozzles in the entire width of the bottom of a glass tank at a certain longitudinal location so as to substantially uniformly diffuse helium, preferably into the entire cross section of the glass flow before and/or during the active fining reactions. The preferred range of the space between helium nozzles is about 1 cm to 10 cm or generally two to three diameters of the helium gas bubbles. The total number of helium nozzles depends on the size and pull rate of the glass tank as well as the size of the helium bubble. Sufficient nozzles need to be placed so as to achieve a helium concentration in glassmelt of about 50 to 80% of the saturation level.

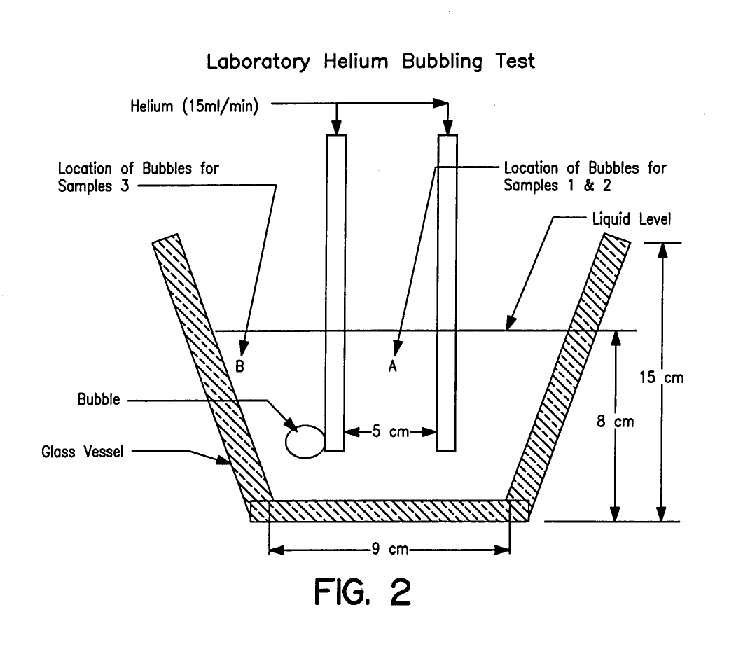

FIG. 2 shows a schematic of a laboratory glass melting set up with a sample crucible with two tubes inserted into the glass melt. The dimensions of the laboratory set is as follows: C=15 cm; D=8 cm; E=5 cm; and F=9 cm. Approximately 200 grams of typical flint or float glass batch materials and variable amounts of sodium sulfate and carbon were placed in the crucible and melted for about 1 hour at 1300° C. in a furnace. The sample crucible was 9 cm in diameter at the bottom with gently sloping sides to a height of 15 cm. The melt depth in the sample vessel was approximately 8 cm. The tubes were used to introduce helium into the glass melt at a rate of about 15 ml/min. The sample crucible and tubes were made from silica. The size of the helium bubbles created was about 1 cm to 2.5 cm in diameter. Letters A and B designate locations where defect bubbles were observed for size and composition analysis. Sample point A is located in the center of the glass melt. Sample point B is located against the vitreous silica crucible. Results of defect bubble analyses are presented in Tables 1 and 2.

### Defect Bubble Analysis in Glass Sample

TABLE 1

| | | | | |
|---|---|---|---|---|
| | | | | Bubble |
| | Helium | | Slow | Sample |
| | bubbling for | Rapid | Cooling | Point |
| Sample # | 30 minutes | Quenching | (refining) | (A or B) |

| | | | | |
|---|---|---|---|---|
| 1 | No | No | Yes | A |
| 2 | Yes | Yes | No | A |
| 3 | Yes | No | Yes | B |

TABLE 2

| | Glass Melt Composition | | | | | | |
|---|---|---|---|---|---|---|---|
| | | | Avg. | | | | |
| | | | Bubble | Gas Composition in Bubbles | | | |
| Sample | % | % | Dia. | Avg. % | Avg. % | Avg. | Avg. % |
| # | Na₂SO₄ | Carbon | (m m) | CO₂ | O₂ | % N₂ | He |
| 1 | 0.25 | 0.05 | 0.24 | 94.5 | 1.5 | 3.9 | 0.0 |
| 2 | 0.00 | 0.10 | 0.36 | 41.0 | 0.8 | 1.5 | 56.6 |
| 3 | 0.25 | 0.05 | 0.14 | 58.1 | 36.5 | 16.0 | 3.9 |

Table 2 gives the analysis averages for five or six defect bubbles in each sample. Samples varied by glass composition, with and without helium bubbling and with or without refining, i.e., secondary fining. The refining for these glass samples were done in which the melt was held at 1425° C. for 30 minutes, then the melt was cooled slowly to 1200° C., at a rate of 1° C./minute. Upon reaching the temperature of 1200° C. the melt was quenched to 600° C. followed by annealing to room temperature at a rate of 2° C./minute. The bulk composition for each melt was typical for float glass, except sample 2 had 0% weight Na₂SO₄, and 0.15% weight carbon while samples 1 & 3 had 0.25% weight percent Na₂SO₄ and 0.05% weight carbon.

Sample 1 did not have helium bubbling but was refined and found to have undissolved/phase-separated silica at the surface and several small blisters in the bulk. Carbon dioxide is the major component in the gas bubbles. Sample 2 did have helium bubbling but did not have refining. The glass sample does not have the undissolved/phase-separated silica but does have a significant amount of defect bubbles. Sample 3 does not have undissolved/phase-separated silica or bubbles in the bulk of the glass sample. Defect bubbles in sample 3 were found only along the wall of the sample crucible. Carbon dioxide and oxygen make up the major constituents of these bubbles. The formation of bubbles found in sample 3 are believed to be caused by interactions of glassmelt and the silica crucible wall and should not be considered as residual not removed during the fining process.

A comparison of samples 1 and 3 show the importance of helium bubbling on the elimination of glass defects. Comparison of samples 1 and 3 also show that a reduction in sulfate concentration is possible. Reducing or eliminating sulfate will reduce the emissions of sulfur dioxide which is an environmental concern. It is also possible with the aid of helium fining to lower the peak temperatures in the furnace and lead to lower volatilization and emissions of particulates, lower fuel cost and longer refractory life. Samples 2 and 3 show that the elimination of defect bubbles is not from just one mechanism. The defect bubbles in sample 2 are those defect bubbles that were in the melt but did not grow large enough to leave the melt during the helium bubbling interval. Sample 3 shows that with a refining step the defect bubbles remaining in sample 2 might have left the melt due to buoyancy forces or dissolved back into the melt. The opportunity for the bubbles to dissolve quickly could have been from the helium bubbles stripping the soluble gases from the melt.

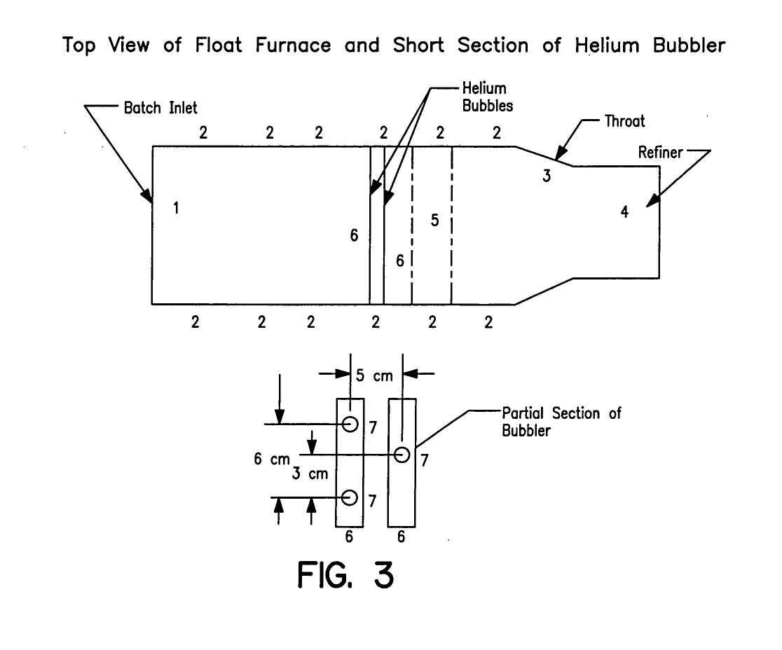

The view in the upper portion of FIG. 3 shows the top view of a typical float glass furnace. The following example is based on a 500 ton/day float glass furnace. Batch enters the furnace at zone 1 and is melted by combustion of natural gas with air through ports 2. Batch melts as it travels towards spring zone 5 and should be completely melted before reaching spring zone 5. Bubblers 6 are located just before spring zone 5. The glass melt then travels through the waist zone 8 into the refining zone 9 and out through the exit canal 10. In the view in the lower portion of FIG. 3, rows of helium nozzles 7 are located in between two separate lines 11, and spaced as follows: A=5 cm; B=6 cm; C=3 cm. Each helium nozzle 7 in the bubbler pipe is located 6 cm (B) from the next helium nozzle in a row in this example. The center of the second bubbler pipe is located 5 cm (A) down stream of the first bubbler pipe row. The pipes can be made of platinum, rhodium, molybdenum, water cooled steel, or refractory material coated with a noble metal. Helium nozzles on the second bubbler pipe are placed the same distance apart at 6 cm as the first bubbler pipe. Helium nozzles of the second bubbler row are offset by 3 cm (C). Instead of bubbler pipes, bubbler nozzles can be incorporated in the furnace bottom refractory block in the same geometrical configurations. Helium bubbles are introduced into the melt at a typical rate of 700/second and a size of about 2 cm in diameter. If each nozzle generates a bubble every two seconds, then 1400 nozzles are required in this example. If the furnace width is 10 meters wide, then 167 nozzles can be placed per single bubbler pipes. Thus, eight to nine bubbler rows, spaced apart by about 5 cm for each row, are required.

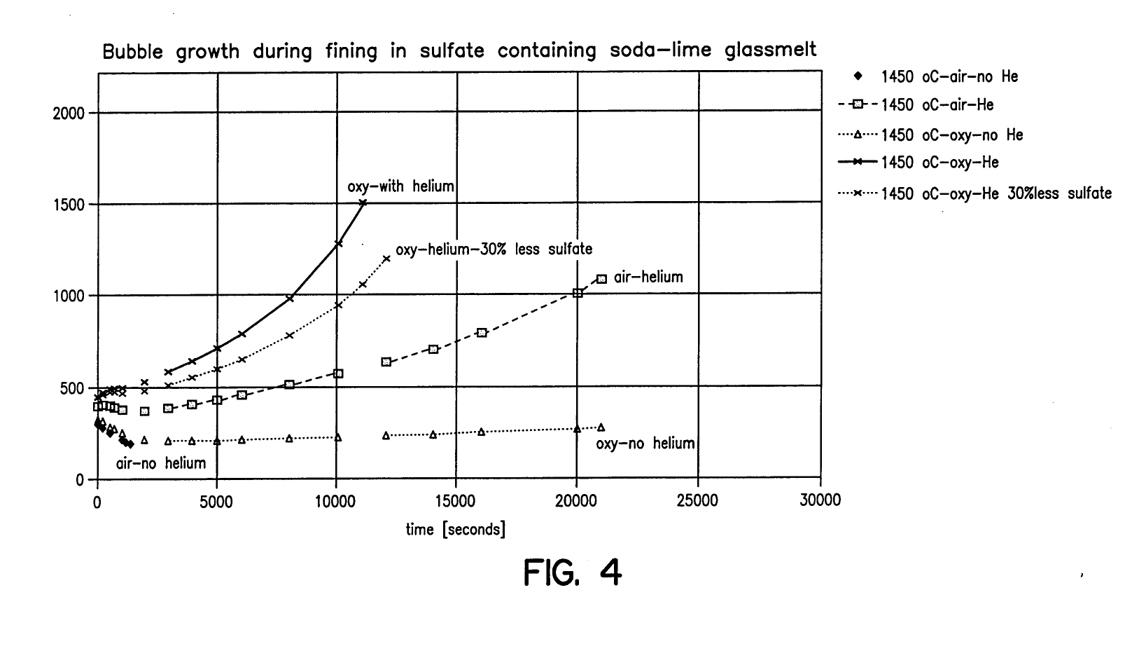

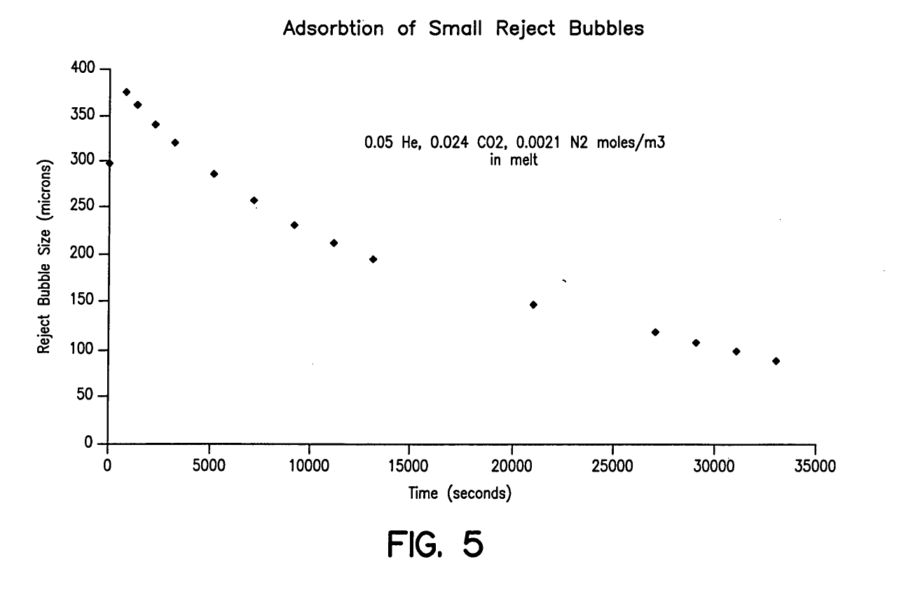

For an air-natural gas fired furnace, the helium should reach a steady state saturation level of approximately 70% to 80% (˜0.11 mol/m³ for soda-lime glass) in the melt and strip 20% to 40% of the carbon dioxide and nitrogen. The diffusing helium will grow bubbles according to FIG. 4, which shows that the growth rate of a bubble is enhanced substantially with dissolved helium. This also applies to oxy-fuel fired glass melters where water content of glass is higher than that in air-fuel fired glass melter. The melt will pass from spring zone 5 to waist zone 8 and into refining zone (working end) 9. In refining zone 9, glass cools down and any remaining small bubbles will be re-absorbed into the melt (FIG. 5). Before leaving the glass furnace through a canal or a throat the melt will be effectively free of bubble defects.

The novel process of the subject invention for fining glass with helium bubbles of a specified size and rate can improve glass quality while allowing a reduction in other fining agents. Bubbles introduced into the melt at the optimum size and rate will reduce the concentration of soluble gases in the melt and grow existing bubbles. Larger bubbles will leave the glass melt through buoyancy. Smaller bubbles will adsorb into the melt as the glass cools. Fining glassmelt with helium can allow the reduction of fining agents that cause environmentally harmful emissions from the furnace or impact the desired final glass appearance.

The preferred process as described in FIG. 3 uses 700 (2 cm in diameter) bubbles per second to attain approximately 70% saturation. A modification to the process would be to increase the helium saturation in the melt by bubbling at a rate of 2000 bubbles per second. According to the glass melt bubble behavior model, the helium saturation level will approach 90%. Depending on the furnace design and glass melt composition, a saturation level of 90% may be necessary to fine (remove dissolved gases and gas bubbles from) the melt. With a melt that is helium saturated to 90% a secondary bubbling system downstream of the helium bubbler may be necessary to lower the helium concentration. The downstream bubbler may use oxygen or water or a combination of the two. FIG. 5 shows the resorption rate of small reject bubbles with various concentrations of helium in the melt. This figure shows that the rate of bubble shrinkage (i.e., resorption) is retarded in glassmelt with a high concentration of dissolved helium. Thus, stripping of dissolved helium with other gas bubbles may become an important step to produce seed-free glass.

The novel helium fining process placed a range on bubbles from 0.5 cm to 4 cm in diameter based on viscosity and depth in a float furnace. Other furnace designs can have a depth that is deeper or shallower than the 1 to 1.5 meter depth of a float furnace. Glass melt compositions can also vary and may have much higher viscosity.

The final glass appearance is sensitive to the glass composition including the amount of dissolved gases. The best fining mechanism may include a second gas mixed with the helium or separate injection. For instance, if a melt required additional oxygen to achieve the desired color, then oxygen could be mixed with helium. The helium bubble size and/or rate would be adjusted to account for the presence of oxygen. In a preferred arrangement the same effect could be achieved by introducing the oxygen in a separate bubbler either upstream or downstream of the spring zone.

The position of the helium bubbler is preferably placed upstream of the spring zone for a float glass furnace or other furnaces of similar design. Vertical furnaces or furnaces similar to the LCD furnace can have helium bubblers located elsewhere. A vertical furnace may place the helium bubbler close to the furnace outlet. A LCD furnace may place the helium bubbler in the fining section before the stirrer.

The invention is not limited to the embodiment shown and it will be appreciated that it is intended to cover all modifications and equipment within the scope of the appended claims.

What is claimed is:

1. A process for fining glassmelt comprising the steps:
(a) charging glass forming raw materials into a furnace and heating said raw materials sufficiently to form a glassmelt;
(b) feeding helium bubbles having a diameter of between about 0.5 cm and about 4 cm into the glassmelt;
(c) maintaining the helium bubbles in the glassmelt for a sufficient period of time to allow the helium gas from the helium bubbles to diffuse into other gas bubbles in the glassmelt to produce larger bubbles of a size that causes said resulting larger bubbles to rise out from the glassmelt surface through buoyancy, stripping dissolved gases in the glassmelt and having the smaller soluble gas bubbles adsorbed in the glassmelt during cooling; and
(d) cooling the glassmelt to produce a glass article.

2. The process of claim 1 comprising feeding the helium bubbles into the furnace at an area where the temperature of the glassmelt reaches its highest level.

3. The process of claim 1 comprising feeding the helium bubbles into the furnace at an area before the glassmelt temperature reaches its highest level.

4. The process of claim 1 wherein the diameter of the helium bubbles is less than about 2 cm.

5. The process of claim 1 comprising feeding the helium bubbles into the glassmelt at a rate between about 20 bubbles and about 250 bubbles/minute/ton per day of glass pull.

6. The process of claim 1 wherein the helium bubbles are dissolved in the glassmelt between about 50% and about 90% of the helium saturation level.

7. The process of claim 1 comprising feeding the helium bubbles into the glassmelt from at least two tubes spaced between about 1 cm and about 10 cm apart.

8. The process of claim 2 comprising feeding the helium bubbles into the glassmelt from at least two nozzles spaced apart by a distance of between about two and about three times the diameter of the helium gas bubbles.

9. The process of claim 3 comprising feeding the helium bubbles to the glassmelt at a rate between about 50 and about 150 bubbles/minutes/ton per day glass pull rate.

10. The process of claim 3 comprising feeding the helium bubbles into the glassmelt from at least two nozzles spaced apart by a distance between about 1 cm and about 10 cm apart.

11. The process of claim 10 comprising feeding the helium bubbles into the glassmelt at a rate between about 20 bubbles and about 250 bubbles/minute/ton per day of glass pull.

12. The process of claim 1 comprising feeding a second type of gas bubbles into the furnace to strip dissolved gases in the glassmelt and control redox state of the glassmelt.

13. The process of claim 1 wherein said second type of gas bubbles contain a different gas than helium.

14. The process of claim 12 wherein said second type of gas bubbles comprises oxygen.

15. The process of claim 13 wherein oxygen is the other gas.

16. The process of claim 1 wherein the glassmelt temperature in step (a) is between about 1000° C. and about 1650° C.

17. The process of claim 1 wherein in step (d) comprises less than about 5 seeds in the glass article.

18. The process of claim 2 comprising feeding the helium bubbles to the glassmelt at a rate between about 50 and about 150 bubbles/minutes/ton per day of glass pull.

19. The process of claim 12 comprising feeding the gas bubbles to the glassmelt at a rate between about 50 and about 150 bubbles/minutes/ton per day of glass pull.

20. The process of claim 19 comprising dissolving the helium bubbles in the glassmelt between about 50% and about 90% of the helium saturation level.
